(19) United States
(12) Patent Application Publication
(10) Pub. No.: US 2002/0188704 A1
(43) Pub. Date: Dec. 12, 2002

(54) Upgrade of licensed capacity on computer entity

(76) Inventors: Stephen Gold, Bristol (GB); Peter Thomas Camble, Bristol (GB)

Correspondence Address: Allan M. Lowe, LOWE HAUPTMAN GILMAN & BERNER, LLP (22429), Suite 310, 1700 Diagonal Road, Alexandria, VA, 22314, US

(21) Appl. No.: 09/878,165

(22) Filed: Jun. 12, 2001

(51) Int. Cl. G06F 15/177; G06F 9/00

(52) U.S. Cl. 709/221; 713/100

(57) ABSTRACT

A headless computer entity is provided with a base license key data stored on a raw disk sector separate from a system disk and a data disk. The license key data is used to control the available data storage capacity within the headless computer entity, and protect the computer entity from unauthorized upgrade to a higher product specification. Upgrades in capacity of the computer entity can be achieved without replacement of data disk, by altering an upgrade license key data to allow use of spare data storage capacity on the data disk.

### FIELD OF THE INVENTION

The present invention relates to the field of computers, and particularly although not exclusively to management of licensed capacity of functionality of computer entities.

### BACKGROUND TO THE INVENTION

Headless computer entities, also known as “headless appliances” are known in the art. A known headless computer entity comprises a data-processor, memory, a plurality on input\output ports or the like, and an operating system. Headless appliances are generally designed without user interfaces, and lack a keyboard, pointing device e.g. mouse or track ball, and visual display monitor. This has the advantages both of reducing the cost of ownership, since the cost of a user interface hardware need not be borne by the purchaser, and also inhibiting interference with the operation of the appliance. In a headless computer entity, human administrators are conventionally allowed only very limited access to the computer entity for maintenance, or in some cases no user maintenance is permitted.

Known headless computer entities have fixed data storage disk configurations of a pre-determined data capacity. Advances in hard disk drive technology have increased the available data capacity in hard disk drives to the extent that smaller capacity disk drives of 1 GByte, and below are becoming increasingly rare, whereas higher capacity hard disk drives of 10 GBytes and above are reducing in price. Conventionally, some types of headless computer entity, for example network attached storage devices (NAS), are sold as a range of products, at a range of different prices, with a main differentiator between products in a range being the amount of data storage capacity provided by each computer entity in the range.

For larger computer entities using RAID disk technology, the products are intended to be used at varying disk capacities. However, if a computer entity product started with a smaller disk capacity size, for example, 6 disks in a RAID configuration, as the entry level product, then to upgrade the product additional disks would be needed to be inserted in a RAID back plane. This has significant problems due to the temporary performance loss when new disks are added to a RAID configuration, and if multiple hard disks are added simultaneously, then the computer entity may have major performance loss for several days.

Another upgrade option, which also has problems, is to increase the data storage capacity in chunks of data, by adding complete new RAID volumes to a RAID configuration. However this has the problem that capacity is lost by each new RAID volume due to redundant data overheads, and it also makes capacity increases relatively inflexible.

The inventors that have realized that because the cost of a hard disk drive is becoming less dominant as a proportion of the cost of a headless computer entity for a range of computer entities, each sold with different data storage capacities, it makes sense to use a common type of data storage component, having a same data storage capacity across the whole range, and provide the different user accessible data storage capacities by means of a license scheme. Customers cannot upgrade the disk configuration and increase the amount of application data held on a headless computer entity, once purchased, without violation of the license. This helps to protect against customer mis-configuration of the appliance, and also protects the manufacturers pricing scheme where headless computer entities are sold at a price dependent on data storage capacity.

### SUMMARY OF THE INVENTION

According to specific implementations of the present invention, a headless computer entity having a fixed capacity data storage device at manufacture is provided with a license key data which controls usage of and access to the fixed data storage capacity within the entity. The license key data can be modified to allow extra data storage capacity, as an upgrade provision, without replacing any hardware within the computer entity.

In specific implementations according to the present invention, a fixed amount of data storage capacity is provided in a single large RAID volume, and the amount of data storage capacity available to a user is limited by a license key data. Upgrades of the computer entity to a higher version model having higher data storage capacity can be made by upgrade of the license key data, without the need to modify any hardware within the computer entity.

Providing a headless computer entity having a relatively large amount of built-in data storage capacity at manufacture, whereby access to that data storage capacity is regulated by a built-in license data allows streamlining of manufacture of a headless computer entity, where the hardware is common to a range of headless computer entity products sold with different data storage capacities.

Further, customer upgrade of the data storage capacity may be restricted, by enforcement of data capacity through an on-board data storage capacity licensing mechanism.

Further, by providing a headless computer entity having unused data storage capacity, which may be accessible by purchase of a license upgrade, a user may be supplied with a readily upgradeable headless computer entity which can be upgraded without the need for a manufacturer service visit by technical personnel, since the need to replace data storage hardware is reduced or eliminated.

According to a first aspect of the present invention there is provided a computer entity comprising:

at least one data processor;

a data storage device;

a user interface;

at least one operating system for controlling operation of said computer entity;

a first license key data, said first license key data allowing partitioning of said data storage device to provide a first amount of licensed data storage capacity, wherein said first amount of data storage capacity is lower than a total amount of data storage capacity of said data storage device,

said license key data comprising an upgrade flag data, said upgrade flag data determining whether or not said partitioned data storage capacity can be increased or not; and

a partition size control component configured to read said upgrade flag data and for determining whether an upgrade of said license data storage capacity can occur or not.

According to a second aspect of the present invention there is provided a method of controlling an amount of licensed functionality provided by a computer entity by controlling a licensed partition size, said computer entity comprising:

at least one data processor;

a data storage device;

a user interface;

at least one operating system for controlling operation of said computer entity;

said method comprising the steps of:

storing a first license key data, said first license key data allowing partitioning of said data storage device to provide a first amount of data storage capacity, wherein said first amount of data storage capacity is lower than a total amount of data storage capacity of said data storage device,

said license key data comprising an upgrade flag data, said upgrade flag data determining whether or not said license data storage capacity can be increased or not; and

determining whether an upgrade of said licensed data storage capacity can occur or not by reading said upgrade flag data.

According to a third aspect of the present invention there is provided a method of providing functionality upgrades to a plurality of computer entity after manufacture, said method comprising the steps of:

storing data uniquely describing said computer entity in a database;

receiving a request to modify a functionality of said computer entity;

checking from said data stored in said database whether said computer entity is capable of modification of functionality;

if said data in said database describes said computer entity as being capable of modification of functionality, then providing an upgrade license key data for enabling modification of said functionality of said computer entity.

According to a fourth aspect of the present invention there is provided a method of operating a computer entity for applying a modification of licensed functionality provided by said computer entity, said computer entity comprising at least one operating system and a data storage device, said method comprising the steps of:

providing a first level of functionality according to a first license data stored on a disk sector of said data storage device inaccessible to said operating system;

modifying said licensed functionality provided by said computer entity according to a second license data stored on said data storage device.

Other aspects according to the invention are as defined in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically in external perspective view a headless computer entity according to a specific implementation of the present invention;

FIG. 2 illustrates schematically an architecture of a headless computer entity according to the specific implementation of the present invention;

FIG. 3 illustrates schematically physical and logical disk layers within the headless computer entity structure of FIG. 2;

FIG. 4 illustrates schematically data partitioning of physical data storage capacity within the headless computer entity of FIG. 1;

FIG. 5 illustrates schematically a license key data stored in a raw disk area of a data storage device of the headless computer entity;

FIG. 6 illustrates schematically an upgrade license key data entered via a web administration interface, allowing upgrade of capacity provided by the headless computer entity of FIG. 1;

FIG. 7 illustrates schematically process steps carried out by a capacity management application during a boot up procedure of an operating system of the computer entity;

FIG. 8 illustrates schematically operations carried out in an invalid upgrade license mode, where an invalid upgrade license is detected;

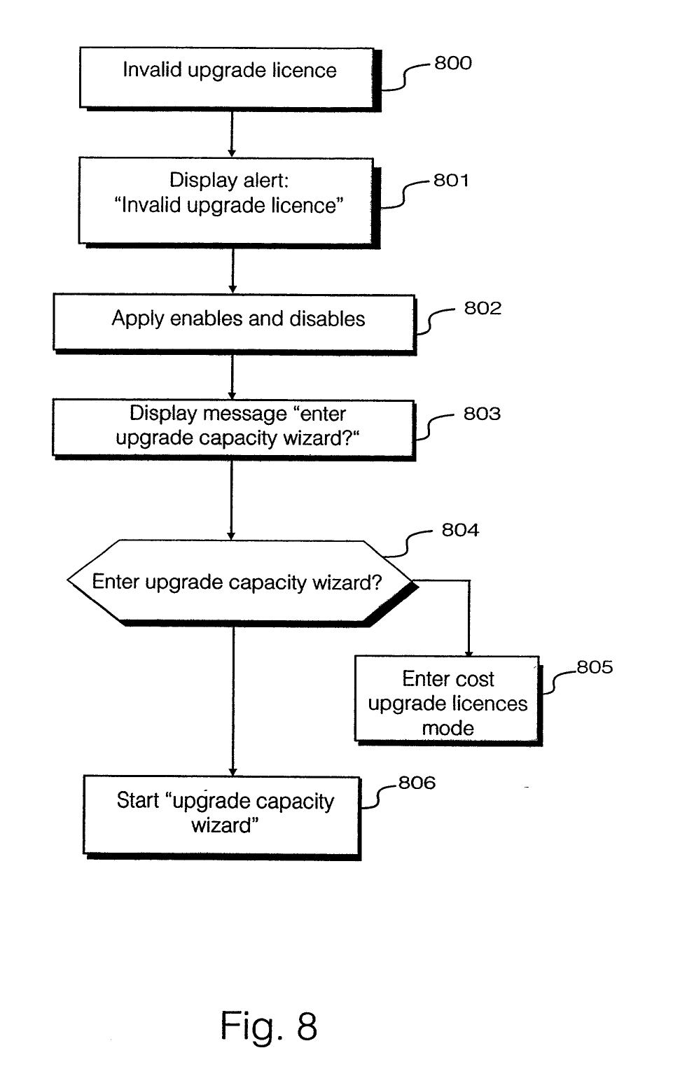

FIG. 9 illustrates schematically operations carried out in a lost upgrade license mode, where an upgrade license has been corrupted or lost;

FIG. 10 illustrates schematically process steps carried out where an upgrade capacity program for enabling a user to install upgrade capacity license for upgrading a data capacity of the computer entity;

FIG. 11 illustrates schematically features which are enabled and disabled in operating modes where an upgrade license is lost, or an upgrade license is invalid;

FIG. 12 illustrates schematically process steps carried out by a vendor fulfillment service for storing data describing a plurality of computer entities, and their data storage capacity;

FIG. 13 illustrates schematically an example of a data entry for a computer entity a database of a vendor fulfillment service, containing data describing information about a customers computer entity; and

FIG. 14 illustrates schematically processes carried out to modify a backup program to take account of changes to upgrade in data storage capacity of a computer entity.

### DETAILED DESCRIPTION OF THE BEST MODE FOR CARRYING OUT THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

In this specification, the term “physical disk” is used to refer to a physically discreet data storage device, provided as a discreet hardware component, and having data storage capacity. A physical disk may include for example a rotating hard disk drive as is known in the art, or a static memory device, such as a Magnetic Random Access Memory device (MRAM).

In this specification, the term “logical disk” is used to describe an area of data storage capacity, physically contained on one or more physical disks, which is treated by a file system of the computer entity as being a single logical drive. For example in a Windows® environment, a logical drive may be given a drive letter e.g. A, B, C, D, E, F etc.

In this specification, the term “logical system disk” is used to describe a logical drive, in which operating system data and application data are stored.

In this specification, the term “logical data disk” is used to describe a logical disk which is used to store raw data, typically, but not exclusively, application data. Data may be stored in a logical data disk in the form of binary large objects (BLOBS).

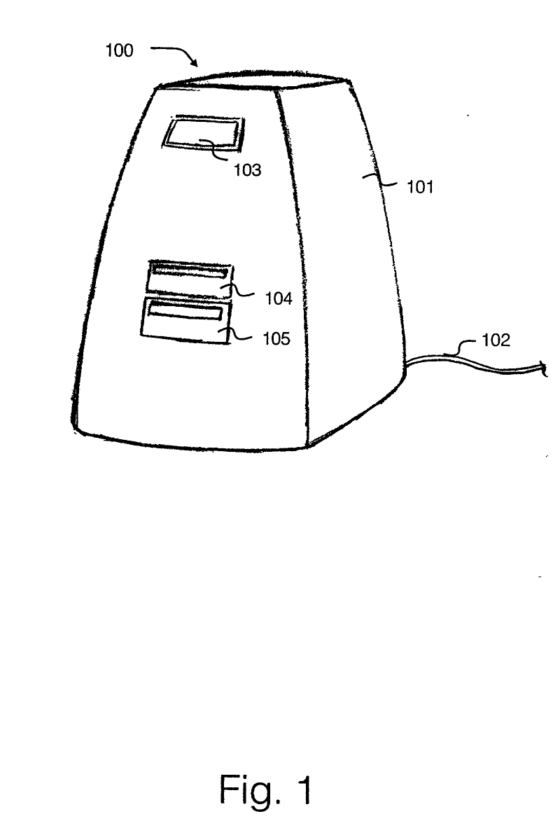

Referring to FIG. 1 herein there is illustrated schematically in perspective view a headless computer entity 100 comprising: a casing 101 containing a processor, memory, one or more data storage devices and one or more communications ports connectable to a local area network 102; a relatively small display screen, for example a liquid crystal (LCD) display 103 capable of giving limited status information for operations carried out by the computer entity, for example, POWER ON mode, a STAND BY mode, and fault modes of operation; a data entry means 104, for example a CD ROM drive, and optionally a back-up data storage device port 105, for example a digital data storage (DDS) format tape streamer.

The headless computer entity is not provided with a visual display monitor, pointing device e.g. mouse, or keyboard, or other direct user interface, and therefore is difficult for a human operator to interact with directly. In operation, the headless computer entity is intended to be self-managing and self-maintaining. Typically, a headless computer entity will provide a dedicated functionality within a network environment. Examples of headless computer entities include network attached storage devices.

In the best mode implementation, a range of headless computer entities having different data storage capacities are provided based upon a common hardware platform having a single large RAID volume, and by limiting an amount of data storage capacity of the computer entity that is actually available to a user, using a software license key data.

For a range of computer entities an entry level computer entity configuration would contain a maximum hardware disk configuration, but be provided with a base software capacity license key which limits how much of the available data storage capacity is available for use by applications on the computer entity. The base capacity license key data defines the entry level data storage capacity, and defines the minimum amount of usable data storage capacity on that computer entity available for use by applications. The base capacity license key data is stored in an area of data storage which is inaccessible to a user or administrator through the operating system.

Additionally, for other member products of the range, having higher data storage capacities at point of sale, there is provided an additional upgrade capacity license key data which defines how much additional capacity over and above the base level which is available for application use in that computer entity. By upgrading the base license capacity key after deployment of the computer entity, users can upgrade their computer entity after purchase without any hardware change, by simply typing in a new upgrade capacity license key obtainable from a vendor. The upgrade paths between individual products in a range can be controlled by the vendor by control of upgrade license key data and the amount of upgrade which can be purchased.

An example of a product range for a network attached storage device, with model types designated PC 300-PC 1,000 using the scalable capacity licensing scheme enabled by the upgrade capacity license keys may be as follows. Each product in the range is based upon an identical hardware platform, with an available amount of data storage capacity usable by applications being limited by the basic capacity license key, and any upgrade license keys installed.

The basic hardware platform may comprise, for example a 700 GigaByte logical data disk provided as a 10 disk RAID5 volume, appearing to an operating system as a second logical disk, the first logical disk being used for storage of applications and operating system. The amount of data storage capacity available for application use varies from products in the range as follows:

PC 300: 700 GigaByte DATA1 volume on logical disk 1 (RAID5 set).

Capacity limit of 172 Gigabyte on DATA 1 volume suitable for 300 users.

PC 400: first upgrade—(75 GigaBytes) increases DATA1 capacity to 245 GigaBytes suitable for 400 users.

PC 500: second upgrade—increases DATA1 capacity limit by 150 GigaBytes to 320 GigaBytes suitable for 500 users.

PC 600: third upgrade—increases DATA1 capacity limit by 225 GigaBytes to give a total of 359 GigaBytes suitable for 600 users.

PC 700: fourth upgrade: increases capacity by 300 GigaBytes, to give a total DATA1 capacity of 470 GigaBytes suitable for 700 users.

PC 800: fifth upgrade—increases capacity by 375 GigaBytes to give total DATA1 capacity of 545 GigaBytes suitable for 800 users.

PC 900: sixth upgrade—gives upgrade of 450 GigaBytes to give total DATA1 licensed capacity of 620 GigaBytes suitable for 900 users.

PC 1,000: 700 GigaByte DATA1 volume on logical disk 1 (RAID5 set). Capacity limit of 700 GigaByte on DATA1 suitable for a maximum of 1,000 users.

In the example above, PC 300 license upgrades are available in modules of 75 GigaBytes between upgrades so that the data storage capacity of the second logical disk partition already existing in the hardware, can be increased in 75 GigaByte amount by addition of a new upgrade software license key. For example, upgrading from an upgrade 3 to an upgrade 5 capacity license gives an upgrade from 395 GigaBytes to 454 GigaBytes data storage capacity.

A PC 300 product allowing for 300 users has 170 GBytes of data capacity provided on a RAID 5 volume, where the RAID 5 volume as a whole is a second logical disk in addition to a system disk. A PC 1000 product suitable for 1,000 users may have 700 GBytes of data storage capacity provided on a RAID 5 volume, as a second logical disk.

In each of the PC 300 to PC 1000 products, each product has two logical disks, one being a system disk and one being data disk respectively, with the logical data disk partitioned into a single data partition, having a capacity based on the base capacity license data 506 specifying the maximum data storage capacity of the single data disk partition.

Replacement of a logical data disk by a larger logical data disk may occur where for example there is a physical disk failure, and the physical disk is replaced with a (higher manufactured data capacity) replacement physical disk, for reasons of cost effectiveness and manufacturing efficiency. However, under these conditions the license key restricts the amount of that potentially available capacity which can be actually partitioned for use as a logical data disk.

If a physical disk is replaced with a larger capacity physical disk, the data partition created on the larger capacity physical disk is the same size as the original data partition on the original data disk. This leaves free space on the larger capacity physical disk, configured as a logical data disk, which is not licensed, and therefore is never used by the computer entity.

Therefore, by using a vendor supplied licence scheme, control of upgrade of data capacity may be passed to the manufacturer, rather than being capable of circumvented by the user of the headless computer entity, and manufacturers may structure product pricing according to licensed capacity on a hardware platform, rather than basing pricing on the provision of hardware components themselves.

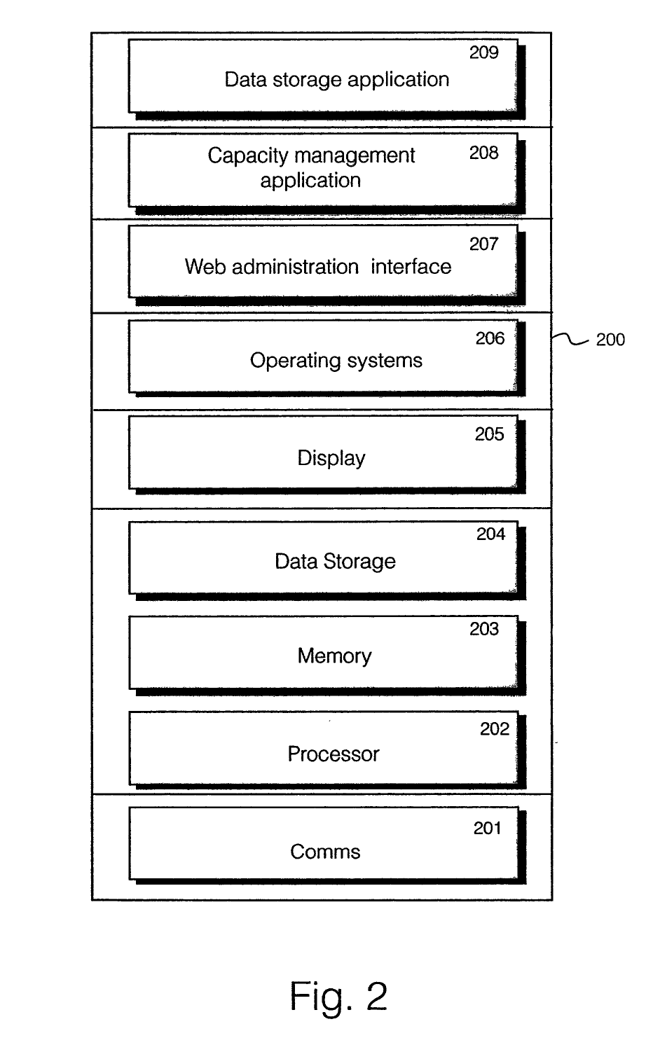

Referring to FIG. 2 herein, there is illustrated schematically an architecture of hardware and firmware components of the headless computer entity 200. The entity 200 comprises one or more communications ports 201; one or more data processing devices 202 as are known in the art; a memory 203 associated with the data processor(s); at least one data storage device 204, for example a hard disk data storage device, or an array of a plurality of hard disk data storage devices; a small display, e.g. a liquid crystal display device 205; a plurality of operating systems 206 as will be described herein after; a web administration interface 207; a capacity management application 208 for managing access and use of the data storage capacity of the computer entity; and one or a plurality of application programs 209 providing functionality to the headless computer appliance.

The operating system 206 is stored on a non-volatile data storage device, for example a hard disk drive, or a RAID array. The operating system 206 comprises a primary operating system, which controls the computer entity under normal operation; an emergency operating system which controls the computer entity at times when the primary operating system is incapable of running the computer entity, for example during a failure of the primary operating system, or during an upgrade or replacement of the primary operating system; and a copy of the primary operating system, comprising a copy of the code files comprising the primary operating system itself, and copies of default data of the primary operating system.

After a failure of the computer entity primary operating system or if the primary operating system is upgraded, or restored from a back-up data storage device, the primary operating system is restored directly from the copy of the primary operating system files and the default data of the primary operating system.

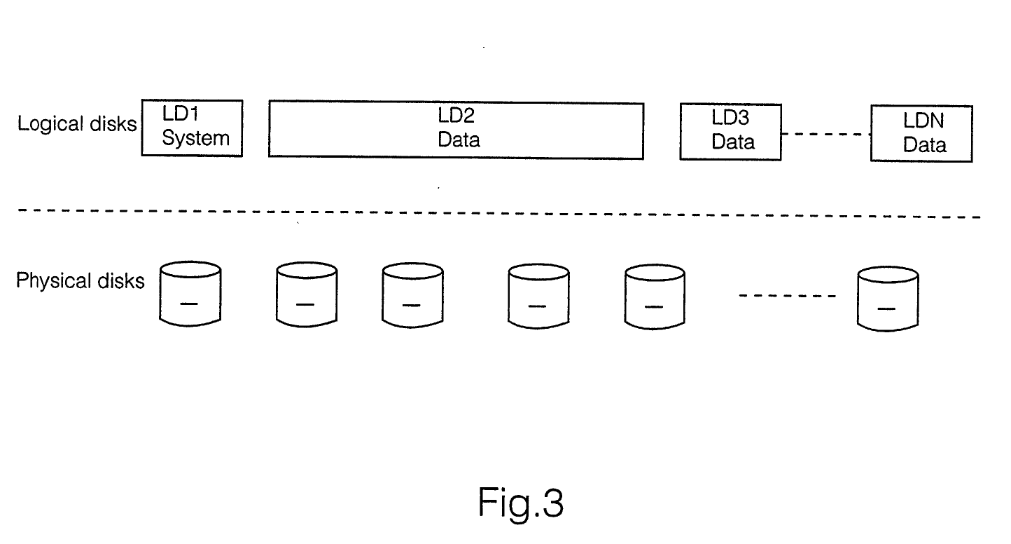

Referring to FIG. 3 herein, there is illustrated schematically data storage device 204 represented as a plurality of physical disks. In various embodiments, the data storage device may be implemented as a plurality of physical disk drives, for example in a plurality of bays mounted on a back plane, in a RAID configuration under control of a RAID controller. The physical data storage devices are divided into a plurality of logical disks. In the case of a single physical data storage device, the logical disks are implemented as first and second partitions on a single physical data storage device. In an array of a plurality of physical data storage devices, one or more logical disks may be implemented as a system disk and one or a plurality of data disks, each implemented as data partitions. In the best mode, the second logical disk is implemented as a RAID 5 array.

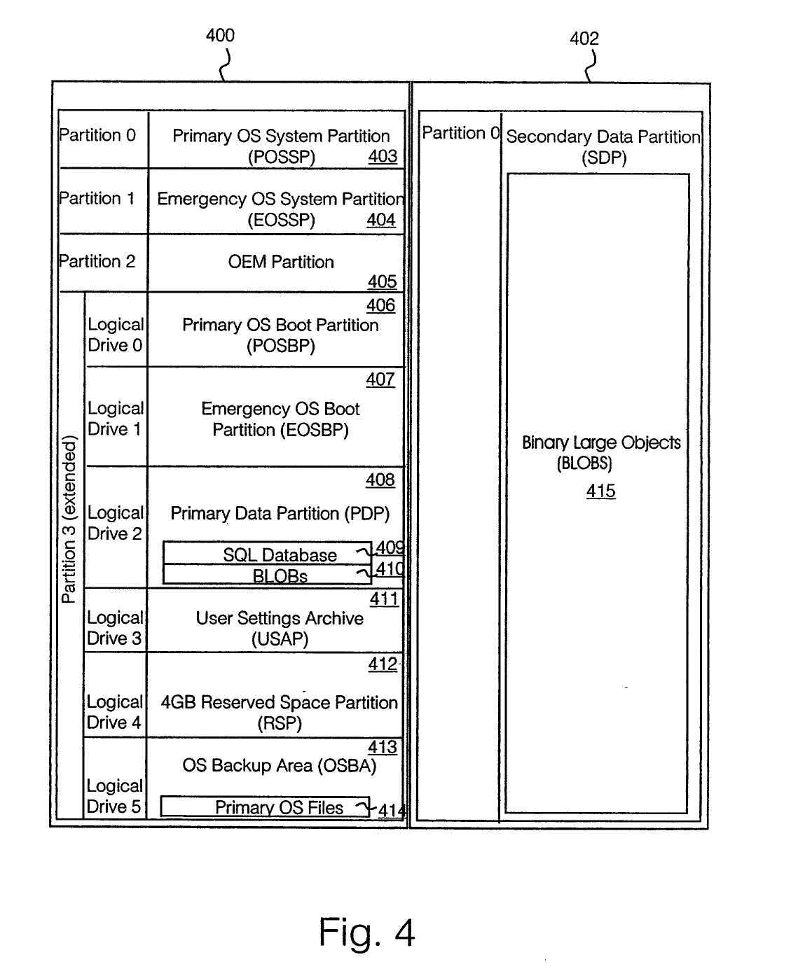

Referring to FIG. 4 herein, there is illustrated schematically a format of data storage device 204, upon which operating systems 206 are stored. The data storage device is partitioned into a logical data storage area 400 which is divided into a plurality of partitioned areas of partitions and sub-partitions according to the architecture shown. The logical data storage area 400 is viewable by a file system on the computer entity. A main division into a primary partition 400 and a secondary partition 402 is made. Within the primary partition are a plurality of sub partitions including a primary operating system system partition 403 (POSSP), containing a primary operating system of the computer entity; an emergency operating system partition 404 (EOSSP) containing an emergency operating system under which the computer entity operates under conditions where the primary operating system is inactive or is deactivated; an OEM partition 405; a primary operating system boot partition 406 (POSBP), from which the primary operating system is booted or rebooted; an emergency operating system boot partition 407 (EOSBP), from which the emergency operating system is booted; a primary data partition 408 (PDP) containing an SQL data base 409, and a plurality of binary large objects 410, (BLOBs); a user settings archive partition 411 (USAP); a reserved space partition 412 (RSP) typically having a capacity of the order of 4 gigabytes or more; and an operating system back up area 413 (OSBA) containing a back up copy of the primary operating system files 414. The secondary data partition 402 comprises a plurality of binary large objects 415.

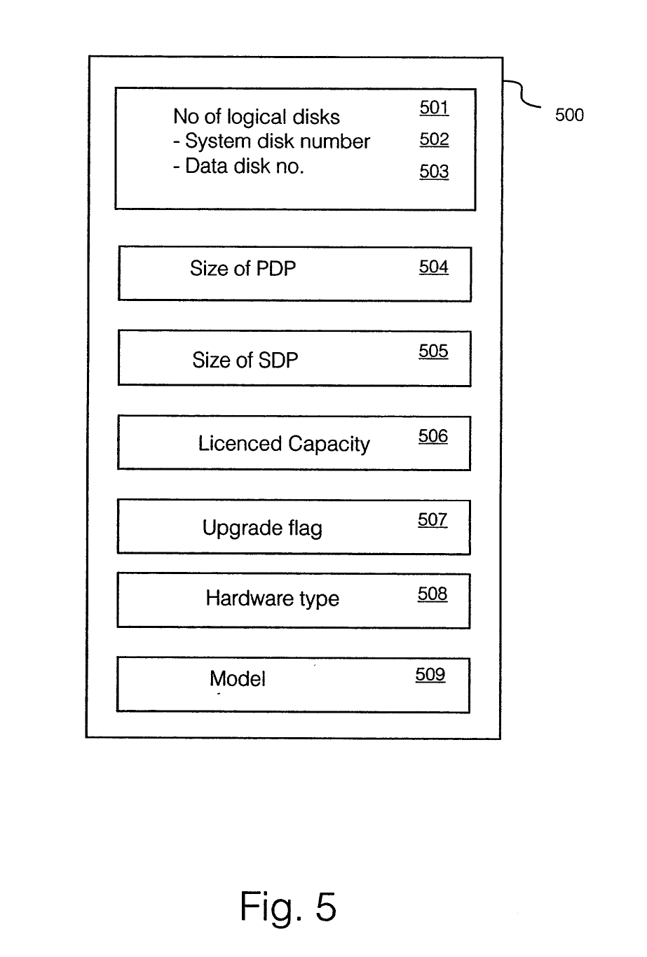

Referring to FIG. 5 herein, there is illustrated schematically a base license key data 500, which is stored on a raw disk sector of data storage device 204. The license key data comprises data 501 describing a number of logical disks resident on the computer entity; a secondary data partition size data 502 describing a memory capacity size of secondary data partition 402; a primary data partition size data 503, describing a memory size of primary data partition 400; a licensed capacity data 504 describing a data capacity size which a user is licensed to access on the computer entity; an upgrade flag data 505 which is factory set and determines whether the computer can be upgraded to have additional data storage capacity accessible to users and enabled by an entry of an upgrade license key data; a hardware type data 506 describing a type of hardware installed in the headless computer entity, in particular a hardware data storage device type; and a model data 507 describing a model type and identification code identifying the particular type of model of headless computer entity.

The base license key records how many logical disks are resident on the computer entity, how those logical disks are partitioned, for example into a system disk (primary data partition) and a data disk (secondary data partition). The base license key is resident outside the file system, on the installed data storage device. Therefore, if the primary data partition and/or secondary data partition are erased for any reason, the base license key, which remains outside those partitions, does not become erased. Any attempts to erase and re-format the primary operating system resident in the primary operating system partition 303 will not affect the base license key data, which is stored outside the file system containing the primary operating system. Consequently, if the primary operating system is erased and re-built, for example as a result of an operating system upgrade, or as a consequence of a failure of the computer entity, then the base license key data remains in tact and unchanged. The base license key data is written to the data storage device once, during manufacture of the headless computer entity, and thereafter is not accessible or changeable, except with replacement of the complete data storage device by a complete new unit, containing a new base license key data.

The base license key data 500, in the best mode, is encrypted. The fact that the base license key is stored outside of the computer entity file systems, and that the base license key is encrypted, means that it does not need to be stored in any computer entity update software for update of operating systems, which may be introduced on a CD ROM carrier. Also in the event of an operating system rebuild being carried out following a fault condition of the computer entity, there is no need to reapply the base license key data after the rebuild. The base license key data maintains itself in a separate area of raw data storage space outside the logical system disk and data disk(s) of the computer entity.

Further, a public key/private key encryption is optimally fixed across different computer entity software builds, so that future major software updates, for example as introduced on a CD ROM carrier, do not have to update the base license key data, and therefore this potential entry for hackers into the base license key data remains closed.

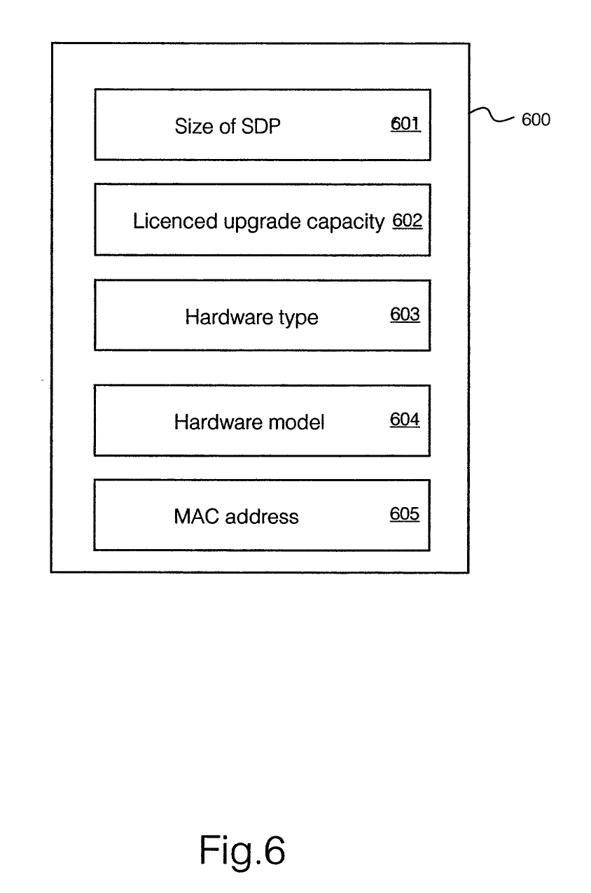

Referring to FIG. 6 herein, there is illustrated schematically components of a capacity upgrade license key data. The capacity upgrade license key 600 comprises data 601 describing an upgraded secondary data partition size. Data 602 describing a licensed upgrade capacity, being an amount of data storage capacity which is enabled by the upgrade license key; a hardware type data 603 describing a type of hardware installed in headless computer entity; a model data 605 describing an upgraded model type and identification code identifying the new model number of the computer entity when the upgrade license key is installed; and a MAC address of the mother board of the computer entity for which the upgrade license key is intended.

The capacity upgrade license key is stored in the user settings archive partition (USAP) 411 as a single “license configuration” file. This means that the upgrade capacity license key needs to be restored during any software reset operation. If the “license configuration” file cyclical redundancy code is invalid when restoring a license upgrade from the U.S. Pat. No. 411, then this constitutes a “lost license” scenario. In this case, during a boot procedure, the boot software should raise an alert message on the web interface/LCD interface reporting “lost upgrade licenses”, and prompt the user to re-install the upgrade licenses. When running in this “lost upgrade license” mode, the capacity limits on the second logical disk partition are based on the basic capacity allowed by the base license key of FIG. 5. The operating system should allow read operations such as recovery, disaster recovery and tape backup operations and disaster recovery CD creation, but will not allow any operation that creates or modifies the application data files, such as client back up jobs or the like.

If an installed upgrade license key does not match a current MAC address of the first local area network port of the computer entity then the operating system displays an “invalid upgrade license” critical alert on the web interface or the liquid crystal display, informing the user that they have to replace the invalid upgrade license with a valid one before the computer entity will accept any further back up jobs. This case may occur when the mother board or a whole computer entity are replaced after a hardware failure or disaster, or if the first local area network port chip fails (which may require a mother board replacement in any case). While running in this “invalid upgrade license” mode, the operating system allows application read operations, for example recovery or disaster recovery operations tape back up operations and disaster recovery CDROM creation, but Will not allow any operation that creates or modifies application data files, such as client back up jobs or the like.

The upgrade license key needs to be restored during any software reset operations.

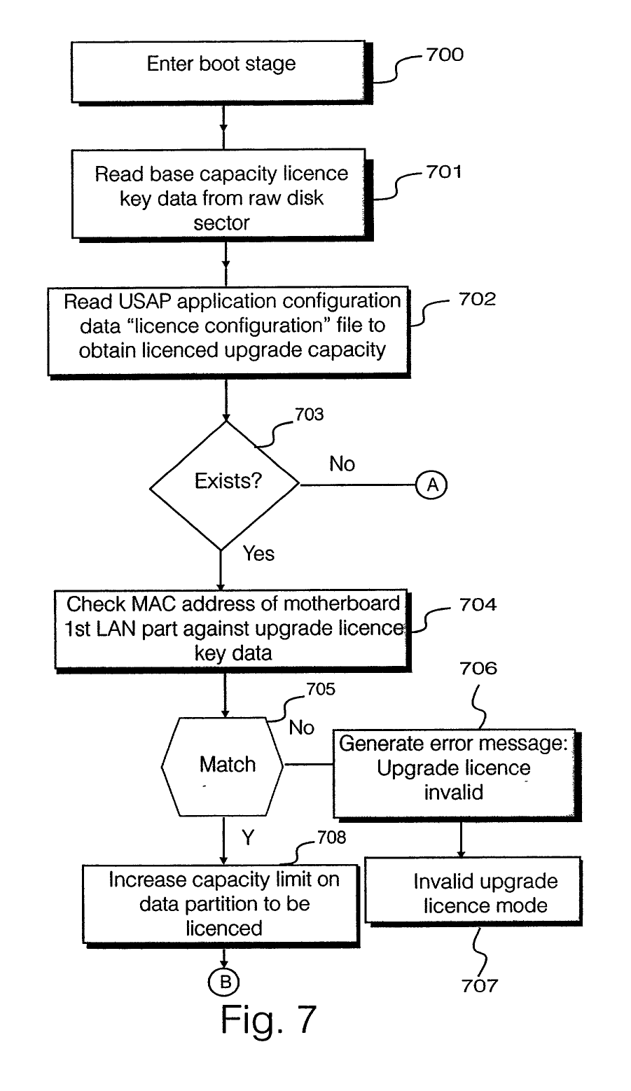

Referring to FIG. 7 herein, there is illustrated schematically process steps carried out by capacity management application 208 during a boot-up procedure of operating system 206. The capacity management application 208 is called during a primary operating system boot-up procedure, to ensure that the computer entity is booted having data storage capacity according to the allowed base licensed data storage capacity stored in the base license key data 500. Following earlier boot stages 700 in the operating system boot-up procedure, in step 701, the capacity management application, having been called by the earlier boot stages reads the base license key data configuration bytes 500 from the raw disk sector. In step 702, the primary operating system checks for the presence of a license upgrade key in the U.S. Pat. No. 411, as a “license configuration” file to obtain a licensed upgrade capacity. If, in step 703, a “license configuration” file does not exist then the operating system skips to step 709 to check the present hard disk configuration and in step 710 compares the present hard disk configuration with the licensed disk configuration according to the base license key. If in step 703 a “license configuration” file does exist, containing an upgrade license key data then in step 704, the operating system checks the MAC address of the first local area network port on the mother board of the computer entity against the data contained in the upgrade license key to make sure that upgrade license key corresponds to the MAC address of the mother board. If a match is not found in step 705, then in step 706 the operating system generates an error message that the upgrade license is invalid and enters an invalid upgrade license mode 707. However, if the match between the MAC address on the mother board and that contained in the upgrade license key does correspond in step 705, then in step 708 the operating system increases the capacity limit on a first data partition DATA1 of the secondary data partition 402 to the licensed amount read from the upgrade license key. In step 709, the capacity management application 208 checks the one or more installed physical disks in the headless computer entity to determine how many physical disks are present, how many logical disks are present, how many logical disks are designated as system disks, and how many logical disks are designated as data disks. In step 710, the capacity management application 208 compares the present hard disk configuration with the base licensed disk configuration stored in the base license key data 500. The checks include:

Whether the correct licensed number of physical disks are actually present.

Whether the correct number of licensed logical data disks are present.

In the case of a single licensed logical data disk, the licensed capacity of that data disk and whether that licensed capacity has been exceeded.

Whether the total licensed data storage capacity is exceeded by one or more logical data disks in the computer entity.

In step 711, as a result of step 710, if the actual present data storage capacity available for use on the computer entity corresponds, within predetermined limits, with the licensed allowable data storage capacity determined by the license key data 500 and the upgrade license key data 600, then in step 712 the operating system boot procedure continues, and control is returned to the primary operating system boot partition 406 to continue boot of the headless computer entity. However, if a violation of license key data 500 and/or upgrade license key data 600 is found in step 711, then in step 713 an error condition is displayed on the web administration interface 207 and/or on the liquid crystal display 103 on the casing of the computer entity, alerting a user to the fact that a capacity license violation has occurred. In step 714, the operating system boot procedure is hatted, preventing operation of the headless computer entity.

To recover from a base license key violation, re-configuration of the physical disks must be made, and this is restricted by installation of a factory supplied replacement physical disks, which contains a pristine copy of a factory configured operating system and new license key data. To recover from an upgrade capacity license key violation, the computer entity will still operate in a mode according to the base license key data, but a correct upgrade license key data containing the correct MAC address of the computer entity needs to be entered into the computer entity.

Referring to 8 herein, there is illustrated schematically operations carried out in an “invalid upgrade license” mode 800 by the computer entity. In step 801, having entered the “invalid upgrade license” mode, the operating system displays a display alert on the web interface and/or the LCD display indicating that an “invalid upgrade license” condition has occurred. In step 802 the operating system an enable to application read operations, whilst disabling modification or creation of application data files. In step 803, the operating system displays a message on the web administration interface and/or LCD display, prompting the user to enter an upgrade capacity wizard, for entering an upgrade capacity license key data. In step 804, if the user does not respond positively to the interrupt grade capacity wizard prompt, then the operating system operates a “lost upgrade licenses” mode in step 805, in which case the computer entity boots into a condition having data storage capacity specified by the base license key. However, if the user responds to the prompt by entering the upgrade capacity wizard, the operating system proceeds to start an upgrade capacity wizard in step 806.

In the case of “invalid upgrade license” mode, when the user runs the upgrade capacity license wizard program it prompts them to input a replacement upgrade license key which matches the upgrade capacity which was perviously installed. If the user enters an upgrade license that matches the mother board MAC address, but is smaller than the previously installed upgrade license key, then the wizard displays an error and prompts the user to enter another key. When the same capacity replacement upgrade license was successfully input, then the computer entity is automatically rebooted.

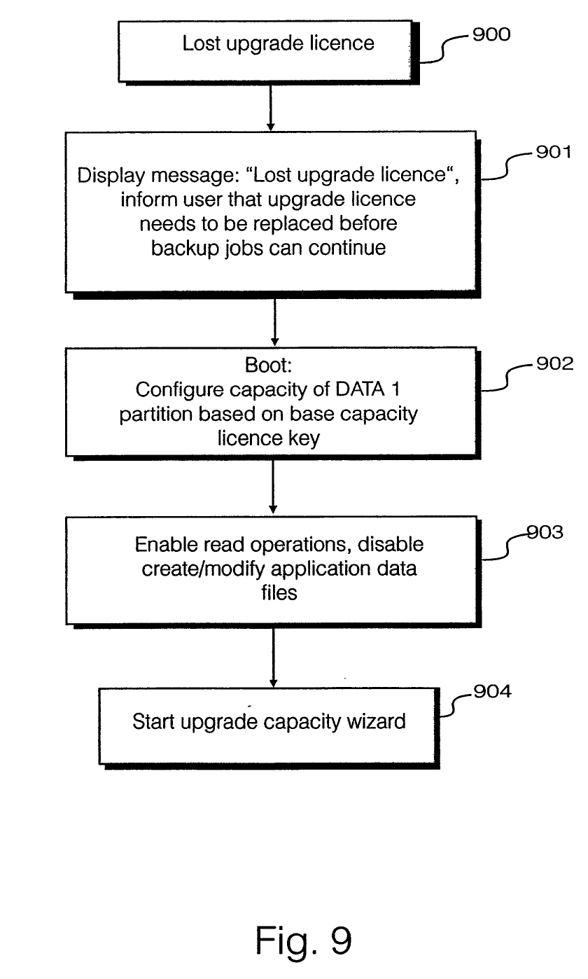

Referring to FIG. 9 herein, there is illustrated schematically operations carried out in a “lost upgrade license” mode 900. In step 901, the web administration interface and/or LCD displays a message that the upgrade license is lost and informs the user that the upgrade license needs to be replaced before any further back up jobs can continue. In step 902 the operating system configures the capacity of the secondary data partition to a capacity based on the base capacity license key. In step 903, read operations remain enabled, however any operations to create or modify application data files are disabled. In step 904, an upgrade capacity wizard program is enabled, to allow a user to apply a new upgrade capacity license key to the computer entity.

While the computer entity is running in “invalid upgrade license” or “lost upgrade license” modes, the upgrade capacity license wizard program displays a prompt at the web interface to input a replacement upgrade license key.

In the case of “lost upgrade license” mode, when the user runs the “upgrade capacity license” wizard program, it prompts the user to re-input their previous upgrade license key, which may have become corrupted during a software reset.

If the “license configuration” file cyclical redundancy code (CRC) is invalid when restoring the license upgrades from the USAP, then this is a “lost license scenario”.

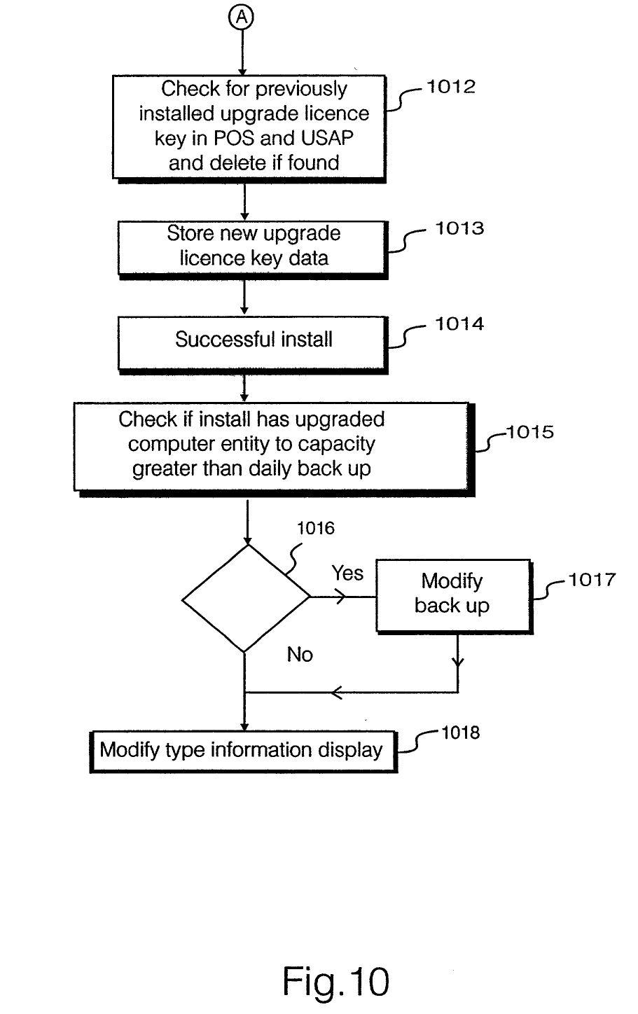

Referring to FIG. 10 herein, there is illustrated schematically process steps carried out by an upgrade capacity wizard program for enabling a user to install an upgrade capacity license via web administration interface 207, using a web browser on a separate computer entity connected to the headless computer entity via local area network 102. An upgrade capacity license key is installed using the web based wizard program through the web administration interface of the computer entity. The upgrade capacity license wizard is only displayed if the computer entity has already established during boot up, that an upgradeable base license key has been found in step 1000. Where a non upgradable base license key is detected, this indicates that the computer entity as sold has a non upgradeable data storage capacity, so the upgrade capacity wizard program does not start.

In the case of an upgradeable base capacity license key being detected in step 1000, in step 1001, the upgrade capacity wizard program starts. In step 1002, the upgrade capacity license program prompts a user to input a system specific upgrade license key. This key is obtained from a vendor fulfillment service. The user obtains the upgrade license key data from a vendor fulfillment service. Typically the user phones the vendors fulfillment service to order or obtain one or several upgrade keys. Typically upgrade keys may be sold in units of 75 GigaBytes, suitable for adding approximately 100 users to the computer entity. The user may obtain a single capacity upgrade license key to enable any additional capacity beyond the base level of capacity provided by the base capacity license key. The amount of enabled extra capacity is encoded in the upgrade license key data. Having obtained the upgrade license key data, the user enters this in step 1003 via the web interface. In step 1004 the program checks the upgrade license key data for validity and a MAC address match. The upgrade license key data is keyed to the MAC address of the first local area network port on the mother board of the headless computer entity, so that the upgrade capacity license key is made system specific to that particular computer entity, and cannot be used on any other similar computer entity. The vendor fulfillment services keeps a permanent record of the amount of capacity upgrades provided for a specific computer entity, identifying that computer entity by the MAC address on the mother board. In step 1005, if the entered upgrade capacity license key passes the check applied in step 1004, then that upgrade license key replaces any previously installed upgrade license keys which may be stored on the computer entity.

If the upgrade license key data is found to be invalid in step 1105, then in step 1006 the program displays an error message notifying the user that the upgrade license key data is invalid, and in step 1007 prompts the user to re-enter the upgrade license key data, returning to step 1002, or alternatively exit the upgrade capacity wizard program in step 1008. If the upgrade license key data is found to be valid in step 1005, then in step 1009 the upgrade capacity wizard program checks that the amount of capacity upgrade encoded in the newly entered upgrade capacity license key is greater than any currently stored upgrade license key which may be installed on the computer entity. If, in step 1010 the amount of capacity upgrade encoded in the newly entered license upgrade key is not greater than a current upgrade license key already stored on the computer entity, then in step 1011, the wizard program displays an error message to the user via the web administration interface, indicating that the upgrade key is of a lower value than an upgrade key already existing on the computer entity, and proceeds to exit the program in step 1008. The existing upgrade capacity license key is retained and the new upgrade capacity license key is not entered.

In step 1013, the wizard program stores the new upgrade license key data in the primary operating system system partition 403, and the user settings archive partition 411 (USAP). In step 1014 provided the new upgrade capacity license key is successfully installed in step 1013, the computer entity enters a “successful install” mode. The computer entity should not need to be rebooted to apply the additional licensed capacity.

Where the upgrade capacity license key causes upgrade of data storage capacity in the computer entity to work capacity which is too large to be backed up by a back up program which operated on the computer entity having the previous unexpanded data storage capacity, as checked in step 1015, then in step 1016, the computer entity enters a modified backup mode 1015 in which back up parameters are modified to take account of the increased data storage capacity of the upgraded computer entity.

In step 1018, where a new upgrade capacity license's key is successfully installed, then information displayed about the computer entity is modified to match the new licensed capacity level of the computer entity. A model type information, which is displayed on the liquid crystal display of the computer entity is upgraded to correspond to the model number matching the licensed capacity. For example where a PC 300 model is upgraded with a 200 user upgrade license (adding an extra 150 GigaBytes of memory), then the model number displayed in the web administration interface and on the LCD graphic would be upgraded to PC 500, Similarly, the model number is upgraded depending upon any other size of data storage capacity upgrade license applied to reflect the total number of users, for example where an extra 400 user licenses added to a base 300 user capacity model (PC 300) then the new model number would be PC 700, and this model number would be displayed on a web administration interface and on the LCD graphic display.

The vendor fulfillment service keeps a permanent record of the amount of capacity upgrades provided for each specific computer entity for which users have requested capacity upgrade license keys.

The vendor fulfillment service should provide a replacement or new upgrade licensed key, and in the case of a new mother board replacement or whole computer entity replacement, the replacement upgrade license key matches the MAC address of the new mother board.

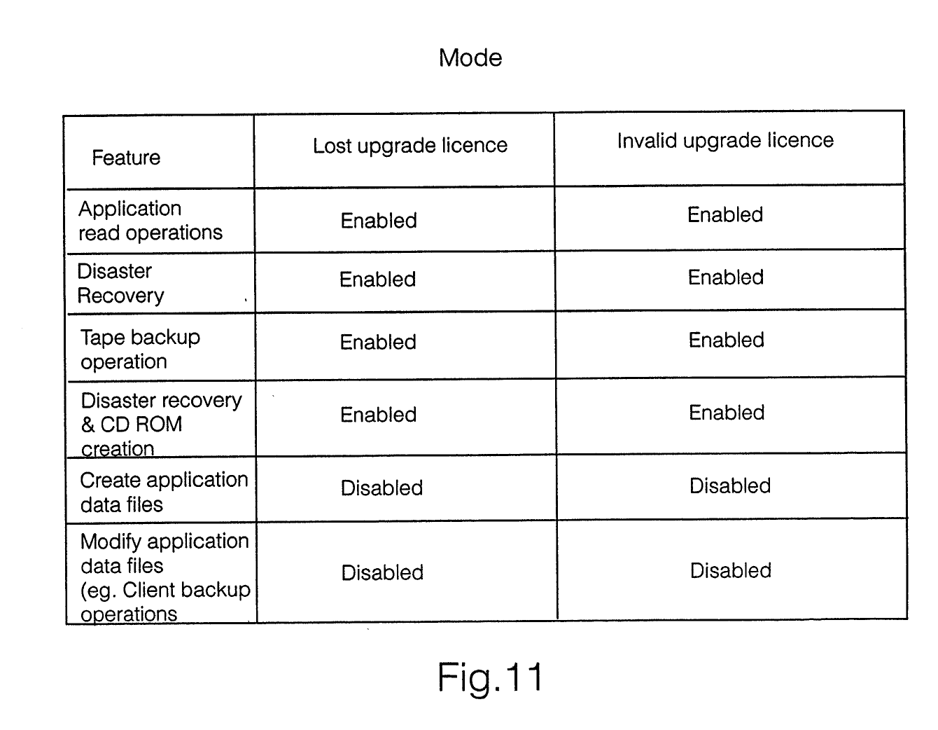

Referring to FIG. 11 herein, features which are enabled and disabled in each of the “lost upgrade license” and “invalid upgrade license” modes are tabulated.

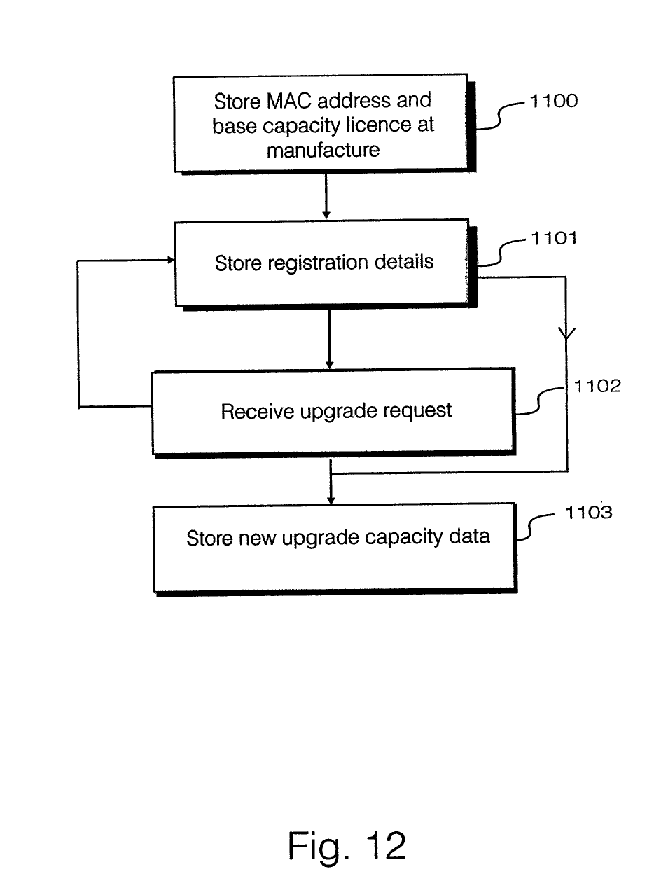

Referring to FIG. 12 herein, there is illustrated schematically process steps carried out by a vendor fulfillment service for storing data describing a computer entity. In step 1200, at manufacture, a MAC address and corresponding base capacity license key data is stored into a database at the vendor fulfillment service at, or shortly after manufacture of the computer entity. Subsequently, the computer entity is supplied to a customer. The customer is encouraged to return registration details after purchase to the vendor fulfillment service, and registration details may be reported via telephone, email or other communication means from the customer to the vendor fulfillment service. The vendor fulfillment service stores these customer registration details in step 1201. Typically this includes the name of the customers organization, and may include details of the MAC address of the computer entity supplied. In step 1202, when the user wishes to upgrade the computer entity, the user calls the vendor fulfillment service either by telephone, email or the like, and specifies the amount of additional data storage capacity to be upgraded. At this point, if the customer has not already provided registration details, in step 1201, then these details are provided. In step 1203, the vendor fulfillment service, having determined payment details, made checks on the allowable upgrade paths of the users computer entity and generated an upgrade license key data, stores details of a new upgrade capacity in the vendors fulfillment database in step 1203.

The new upgrade capacity data stored in the vendor fulfillment database is used when a customer requests an additional upgrade, so that an amount of encoded capacity in a new upgrade license key is calculated as the customers current capacity plus the new purchased upgrade. In cases where a new mother board is replaced, the fulfillment service must be able to supply a replacement upgrade license key which matches the new MAC address of the customer's system, and contains the correct amount of enabled capacity upgrade. The vendor fulfillment service can check the customers licensed current capacity by checking the vendor fulfillment database.

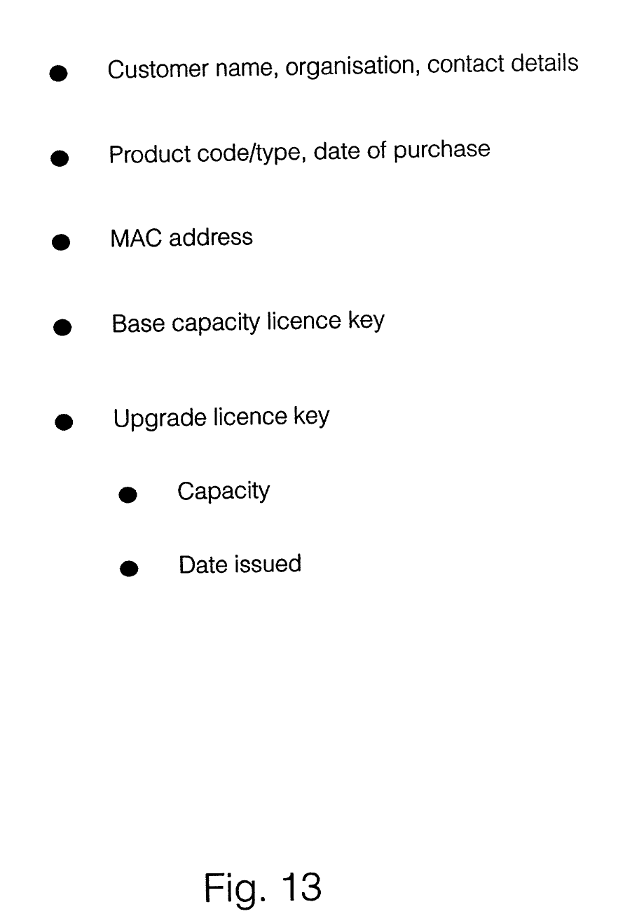

Referring to FIG. 13 herein, there is illustrated schematically details of a customer data entry at the vendor fulfillment database containing data describing information about a customers current computer entity. The data stored includes: a customer name, organization and contact details; a product code/product type for the computer entity which the customer has purchased; a date of purchase; a MAC address of a mother board fitted to the computer entity; a base capacity license key number, and an amount of capacity enabled by that base capacity license key; one or more upgrade capacity license key data, each describing a capacity enabled by that license key and a date that license key was issued.

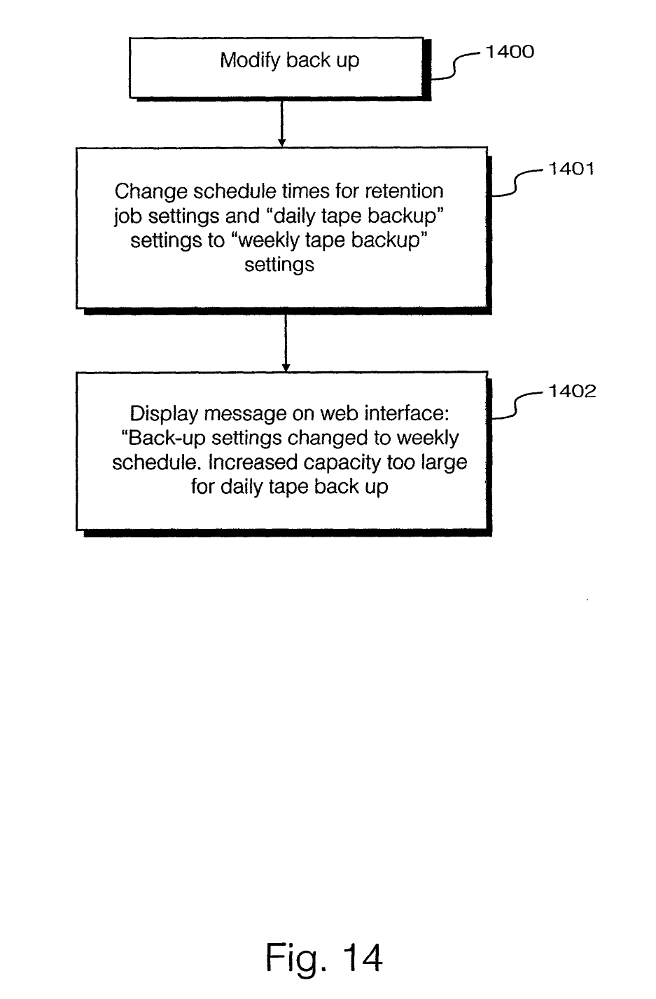

Referring to FIG. 14 herein, there is illustrated schematically process steps carried in out in a modified backup operation, as a result of the upgraded data storage capacity exceeding a capacity of a daily back up tape, and requiring resetting to a weekly back up mode. In step 1401, the upgrade capacity wizard program changes a set of scheduled times for scheduling retention job settings and daily tape back up settings to correspond with a set of settings for a weekly tape back up. In step 1402, the program displays a message on the web interface and/or LCD, to alert the user that the back up settings have been changed to the weekly scheduled settings, because the increased capacity of the computer entity is now to large for the daily tape back up settings to apply.

Provision of a base capacity license key data 500 together with an upgrade license key data available from a vendor may provide various advantages for headless computer entities having fixed disk capacity as follows:

Entry level products can be defined by the base capacity license key data, allowing a pre-determined amount of licensed capacity, but also allowing an upgrade path without the need for addition of extra hardware.

A range of computer entities can be provided, with individual members of the range being differentiated by available data storage capacity, but based around a common hardware platform using the same components throughout the range, with the capacity available for use by the purchaser/user, being controllable by the vendor by means of the base license capacity key, and supply of upgrade license keys.

Users requiring an expansion of usable capacity in a computer entity can expand that capacity without having to make any hardware changes, simply by typing in a new license key data available from a vendor fulfillment service.

Because no hardware upgrades are necessary for applying a capacity upgrade, a service call out is avoided and also a risk of damage to a computer entity through hardware installation problems is avoided.

Providing a capacity upgrade by means of a vendor fulfillment service is potentially quicker than providing a capacity upgrade through hardware replacement, since there is no need for a service engineer call out in order to implement a capacity upgrade. The capacity upgrade can be implemented by the user typing in a new upgrade capacity license key data obtained on line, or from a telephone call with a vendor fulfillment service.

1. A computer entity comprising:
at least one data processor;
a data storage device;
a user interface;
at least one operating system for controlling operation of said computer entity;
a first license key data, said first license key data allowing partitioning of said data storage device to provide a first amount of licensed data storage capacity, wherein said first amount of data storage capacity is lower than a total amount of data storage capacity of said data storage device,
said license key data comprising an upgrade flag data, said upgrade flag data determining whether or not said partitioned data storage capacity can be increased or not; and
a partition size control component configured to read said upgrade flag data and for determining whether an upgrade of said license data storage capacity can occur or not.

2. The computer entity as claimed in claim 1, wherein said partition size control component comprises:
a component for detecting said upgrade flag data; and
a component for storing an upgrade license key data on said data storage device.

3. The computer entity as claimed in claim 1, wherein said partition size control component comprises:
a component for checking a validity of an upgrade license key data.

4. The computer entity as claimed in claim 1, wherein said partition size control component comprises:
a component for checking whether an existing upgrade license key data is already stored on said data storage device.

5. The computer entity as claimed in claim 1, wherein said partition size control component comprises:
a component for reading a licensed upgrade data storage capacity allowed by an upgrade license key data.

6. The computer entity as claimed in claim 1, wherein said partition size control component comprises:
a component for comparing whether an existing license key data stored on said data storage device allows a capacity upgrade greater than a new upgrade capacity license key data requested to be entered onto said data storage device.

7. A method of controlling an amount of licensed functionality provided by a computer entity by controlling a licensed partition size, said computer entity comprising:
at least one data processor;
a data storage device;
a user interface;
at least one operating system for controlling operation of said computer entity;
said method comprising the steps of:
storing a first license key data, said first license key data allowing partitioning of said data storage device to provide a first amount of data storage capacity, wherein said first amount of data storage capacity is lower than a total amount of data storage capacity of said data storage device,
said license key data comprising an upgrade flag data, said upgrade flag data determining whether or not said license data storage capacity can be increased or not; and
determining whether an upgrade of said licensed data storage capacity can occur or not by reading said upgrade flag data.

8. The method as claimed in claim 7, wherein said step of determining whether an upgrade of capacity can occur comprises:
detecting said upgrade flag data; and
storing an upgrade license key data on said data storage device.

9. The method as claimed in claim 7, wherein said first license key data is stored in a data storage area outside a partition used for storing said operating system, and outside said allowed partition providing said first amount of data storage capacity.

10. The method as claimed in claim 7, comprising the step of:
checking a validity of an upgrade license key data by comparing a unique identifier data comprising said upgrade license key data with a unique identifier data read from a component of said computer entity.

11. The method as claimed in claim 7, comprising the steps of:
receiving a new upgrade license key data requested to be entered onto said data storage device;
checking whether an existing upgrade license key data is already stored on said data storage device;
if an existing said upgrade license key data is already stored on said data storage device, comparing whether said existing license key data allows a capacity upgrade greater than a new upgrade capacity specified by said new upgrade license key data requested to be entered onto said data storage device.

12. A method of providing functionality upgrades to a plurality of computer entity after manufacture, said method comprising the steps of:
storing data uniquely describing said computer entity in a database;
receiving a request to modify a functionality of said computer entity;
checking from said data stored in said database whether said computer entity is capable of modification of functionality;
if said data in said database describes said computer entity as being capable of modification of functionality, then providing an upgrade license key data for enabling modification of said functionality of said computer entity.

13. The method as claimed in claim 12, wherein said upgrade license key data comprises:
data uniquely identifying a computer entity to which said upgrade license key applies;
data defining an amount of data storage capacity which said computer entity can access for use by applications.

14. The method as claimed in claim 12, further comprising the step of:
storing a data in said database describing a licensed data storage capacity of said computer entity.

15. A license key data comprising:
data uniquely identifying a computer entity;
data defining an amount of data storage capacity licensed for use by said computer entity.

16. The license key data as claimed in claim 15, further comprising:
data describing a model description of said computer entity.

17. A method of operating a computer entity for applying a modification of licensed functionality provided by said computer entity, said computer entity comprising at least one operating system and a data storage device, said method comprising the steps of:
providing a first level of functionality according to a first license data stored on a disk sector of said data storage device inaccessible to said operating system;
modifying said licensed functionality provided by said computer entity according to a second license data stored on said data storage device.

18. The method as claimed in claim 17, further comprising the step of:
comparing a first unique identifier data stored on said computer entity and uniquely identifying said computer entity, with a second unique identifier data comprising said second license data;
if said first and second identifier data correspond, then permitting modification of said functionality provided by said computer entity according to said data stored as second license data.

19. The method as claimed in claim 17, wherein said modifiable functionality comprises data storage capacity.

20. The method as claimed in claim 17, wherein said modifiable functionality comprises data storage capacity, and further comprising the steps of:
determining a present configuration of said data storage device;
comparing said present configuration of said data storage device with a licensed configuration described by data comprising said second license data;
if a match is found between said present configuration and said licensed configuration, then allowing said computer entity to operate.

21. The method as claimed in claim 17, wherein said modifiable functionality comprises data storage capacity, and further comprising the steps of:
determining a present configuration of said data storage device;
comparing said present configuration of said data storage device with a licensed configuration described by data comprising said second license data;
if said present configuration of said data storage device does not match said licensed configuration of said data storage device, then prohibiting further boot procedures of said computer entity; and
displaying an error condition.
